(19) United States
(12) Patent Application Publication
(10) Pub. No.: US 2023/0380384 A1
(43) Pub. Date: Nov. 30, 2023

(54) PLUSH FETCH AND INTERACTIVE PET TOY

(71) Applicant: Graham Wilson, Denver, CO (US)

(72) Inventor: Graham Wilson, Denver, CO (US)

(21) Appl. No.: 17/829,214

(22) Filed: May 31, 2022

(51) Int. Cl. A01K 15/02

(52) U.S. Cl. CPC A01K 15/025

(57) ABSTRACT

The invention is a plush toy resembling an animal or fantasy character wherein up to 3 squeaking balls are inserted into the mouth of the character and a pet must remove the balls for replay or even a game of fetch before reloading the character with balls.

### FIELD

The present invention relates generally to stimulating, encouraging and motivating games and methods of playing regarding pets, e.g. dogs and cats. More particularly, the invention relates to motivational games, toys and methods for interacting with pets and providing exercise at the same time.

### PRIOR ART

There are many types of pet toys on the market that squeak or that can be used in a tug-of-war game between an owner and a dog, or multiple dogs without their owner's interaction. This novel toy is designed to hold 3 tennis balls inside a plush character body which will eject from the mouth of the character when the pet interacts with the toy. The toy also contains a squeaker which further entices the pet to try to obtain whatever it perceives to be a prize.

### BRIEF DESCRIPTION OF THE INVENTION

The novel design of the inventive toy satisfies a dog's instinct to tug and tear at a toy that makes noise in response or contains an object they have to seek to remove from within. Studies have shown that even the most domesticated dog retains an ancestral instinct to actually kill its prey. Enter toys designed to make sounds in response to the dog's “attack”.

The object of the present invention is to motivate and maintain interest of a pet, and also be a durable toy that continues to function after being aggressively used by a pet. Pet owners spend several billion dollars per year on pet toys, and this toy provides great value for the price. Further, the pet owner can interact by throwing the balls for the pet to fetch, and then stuffing them back inside the toy for re-play.

Veterinarians caution pet owners about using the right kind of toy especially when the pet will be left alone for time periods. The toy should be durable, and not contain small pieces easily swallowed, yet still provide that action of having to get the balls out of the toy to play with. The inventive toy meets that criteria as well as providing the stimuli that will keep a dog interested in the toy, and hopefully not so interested in the couch.

### BACKGROUND OF THE INVENTION

The invention most closely corresponds with USPTO Class 119/707 wherein Class 119 relates to animal husbandry and sub-class 707 includes toys.

In its simplest form, the invention relates to a novel toy for pets wherein a plush toy character such as a pig, cow or even a fantasy character such as a dragon has a large mouth opening wherein 3 tennis balls can be stuffed inside and require the pet to get them out. The pet owner can also involve a fetch game and require the pet to bring the balls back for reinserting and the game begins again.

### THE INVENTION

### SUMMARY, OBJECTS AND ADVANTAGES

It well known that pets do experience a sense of boredom, and if not addressed, may manifest in negative behavior such as chewing furniture or going to the bathroom in undesirable locations in the pet owner's home. When presented with a toy that makes a high-pitched squeaky noise, many dogs will revert to a stylized version of the shake and kill pattern of their wild ancestors. Having a toy that merely squeaks is a positive step, but having a toy where the dog can actually be rewarded by getting something “out” adds significant stimulation. The dog can continue to play with the balls until its owner re-stuffs the toy and the dog gets to repeat the behavior. It can be appreciated in the art that the balls used with the toy can include balls constructed of different materials such as rubber or plastic and embodiments are not limited to tennis balls.

### BRIEF DESCRIPTION OF THE DRAWINGS

The invention is described in further detail by reference to six (6) drawings sufficient in detail to describe the invention in which:

FIG. 1 is a front view of the plush toy with ball in place;

FIG. 2 is aside perspective of the plush toy;

FIG. 3 is a view of the balls for the toy;

FIG. 4 shows the toy without balls inserted;

FIG. 5 is a view of the plush turned inside out; and

FIG. 6 shows the inside lining of the body of the plush toy and the squeaker which will be sewn in to the head portion.

### DETAILED DESCRIPTION, INCLUDING BEST MODES OF CARRYING OUT THE INVENTION

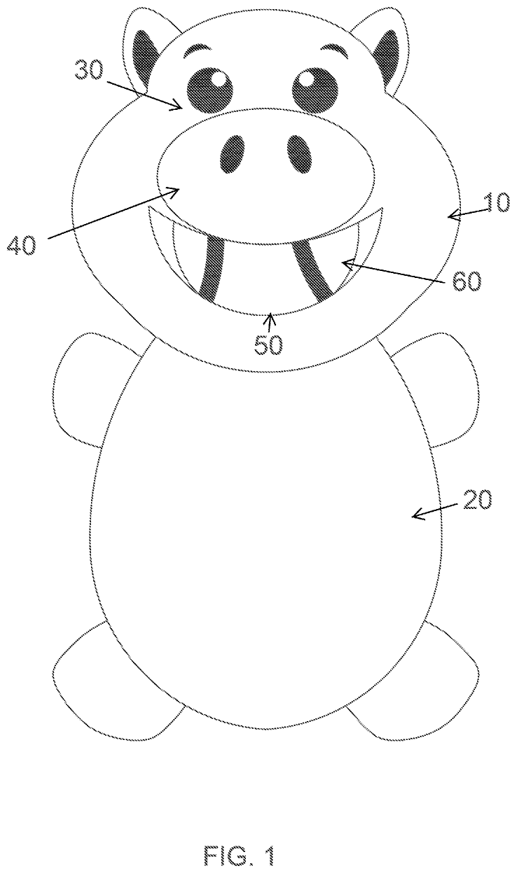

FIG. 1 shows the plush character head 10 and body 20. The body of the toy has only a polyester lining sewn to it so that the balls 60 can be easily inserted and removed without being held up by a nappier fabric. The head of the toy 10 is sewn to the body and its cavity does not open to the inside of the body so as any noisemaking items such as squeakers will not be accessible and thus a danger to the pet by swallowing. The instant embodiment of a pig character head with facial features 30 which are embroidered thereupon. The nose portion 40 is piece construction with polyfill inside and set to the head of the pig. The wide mouth 50 is designed for the balls to be inserted into and for the pet to maneuver them out. Up to 3 balls 60 can be inserted at one time.

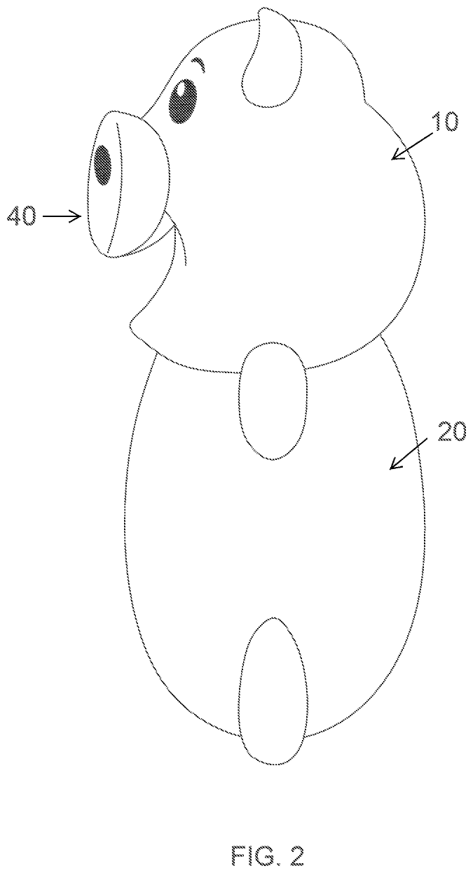

FIG. 2 is a side view of the pig character showing the extrusion of the nose 40 and providing a general view of the shape of the plush toy. Again the facial features 30 are shown.

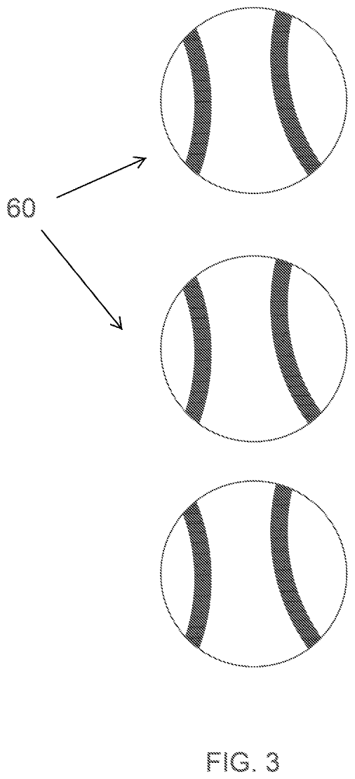

FIG. 3 is an illustration of the balls 60 which are squeaking tennis balls, Grade A+. The mouth of the toy is sized so that the balls are easy to stuff back in the toy, but small enough that the pet has to work a little bit to get them out.

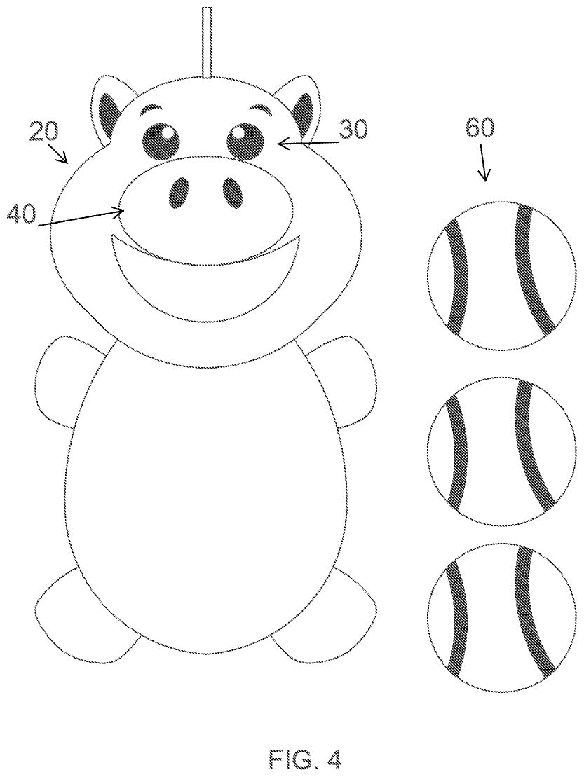

FIG. 4 is simple illustration of the plush toy and the balls. This would be a good place to note that the head 20 is turned 3D construction and lined with 210D polyester. Facial features 30 are embroidered. The nose or snout 40 is pieced construction with polyfill inside and set onto the head 20. Again the balls 60 are squeaking tennis balls, Grade A+. The toy will hold up to three balls.

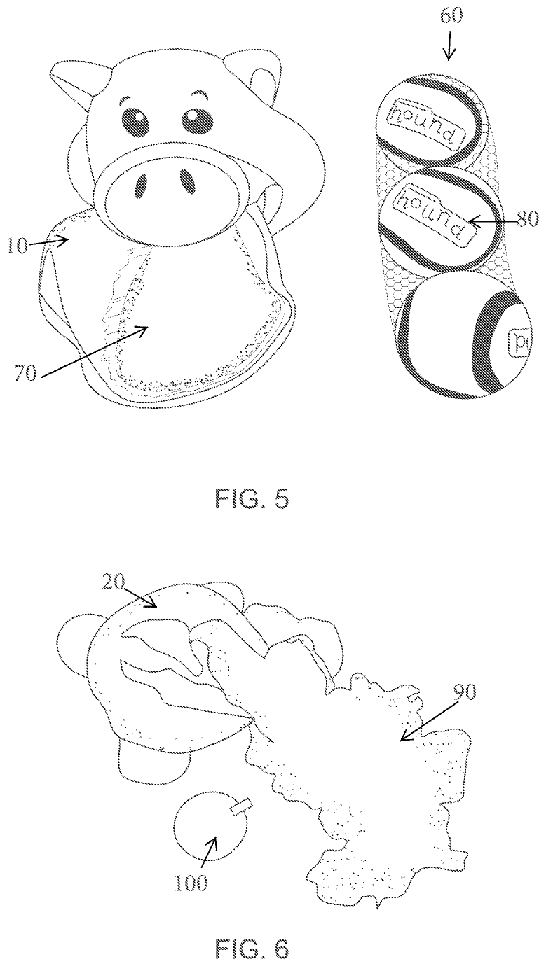

FIG. 5 shows the plush toy body 10 turned inside out to illustrate the polyester lining 70. There is no stuffing or filling material in the toy body. The balls 60 are shown with the brand name 80 as heat sealed onto the balls.

FIG. 6 shows the plush toy head 20 turned inside out to illustrate the polyfill batting 90 inside the head portion of the toy, and the squeaker 100 which is set inside the batting. The batting and the squeaker are sewn into the head so that a pet is not in danger of accessing the items and to prevent choking hazards. The head portion is then fixed to the body portion so that only the balls can be accessed and removed by the pet.

1. A pet toy comprising:
a) A plush toy with a head, body, 3-D and embroidered facial features, limbs or wherein the toy can be shaped in characters made to look like food items;
b) A single opening to insert and remove balls;
c) A body cavity to allow only up to three balls;
d) Squeaking balls;
e) Body cavity lining of smooth polyester sewn to the outer body plush; and
f) At least one of a squeaker within the plush toy head.

2. A pet toy as in claim 1 wherein a plush fabric forms a head and body of a plush toy animal and wherein the head is enclosed and affixed to the body of the toy, which body is hollow.

3. A pet toy as in claim 1 wherein facial features are embroidered onto the plush fabric, and wherein an extended snout or nose is pieced construction with polyfill inside and protrudes from the head to make the feature 3D.

4. A pet toy as in claim 1 wherein the plush toy head is sewn shut and attached to the body of the toy and wherein the head is stuffed with polyfill and contains at least one of a noisemaking device.

5. A pet toy as in claim 1 wherein only a single opening is created of the mouth of the plush toy, and wherein only the mouth feature of any embodiment is used for inserting and removing up to 3 squeaking balls, wherein the balls can be made of rubber or plastic.

6. A pet toy as in claim 1 wherein the body of the plush toy animal is devoid of filling, but has a layer of smooth polyester fabric sewn is a lining for reducing friction when the balls are being inserted or removed.

8. A pet toy as in claim 1 wherein polyfill batting sewn inside the plush toy head holds at least one of a noisemaking device and which device cannot enter the hollow body cavity of the toy.

9. A pet toy as in claim 1 wherein a plush body can include shapes other than animals and can include shapes resembling food items such as cupcakes or mushrooms.
